(19) United States
(12) Patent Application Publication
(10) Pub. No.: US 2016/0216944 A1
(43) Pub. Date: Jul. 28, 2016

(54) INTERACTIVE DISPLAY SYSTEM AND METHOD

(71) Applicant: FIH (HONG KONG) LIMITED, Kowloon (HK)

(72) Inventor: NAI-LIN YANG, New Taipei (TW)

(21) Appl. No.: 14/680,712

(22) Filed: Apr. 7, 2015

(30) Foreign Application Priority Data
Jan. 27, 2015 (CN) 201510040421.1

(51) Int. Cl. G06F 3/16; G10L 17/22; G06T 13/40; G06T 13/80; G06F 3/0484; G06F 3/0488

(52) U.S. Cl. CPC G06F 3/167; G06F 3/04847; G06F 3/0488; G06T 13/40; G06T 13/80; G10L 17/22

(57) ABSTRACT

An electronic device includes a touch panel, a storage device, at least one processor, and one or more modules that are stored in the storage device and executed by the at least one processor. The one or more modules includes a voice obtaining module, an identifying module, and an executing module. The voice obtaining module receives voice commands from users and pre-processes the voice commands. The identifying module acquires characteristics of the voice commands and compares the characteristics of the voice commands with a sound database stored in the storage device to obtain an identification result. The executing module executes data of animated visual images stored in the storage device according to the identification result to show the animated visual images on the touch panel.

### FIELD

The subject matter herein generally relates to display systems, and more particularly to an interactive display system and an interactive display method of an electronic device.

### BACKGROUND

In recent years, researches for non-contact type human-machine interactive system (i.e., a three-dimensional interactive system) have been rapidly grown. The three-dimensional interactive system can provide operations more close to actions of a user in daily life, so that the user can have a better controlling experience.

### BRIEF DESCRIPTION OF THE DRAWINGS

Implementations of the present technology will now be described, by way of example only, with reference to the attached figures.

FIG. 1 is a block diagram of an electronic device employing an interactive display system, according to an exemplary embodiment.

FIG. 2 is a flowchart of one embodiment of an interactive display method using the interactive display system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to an interactive display system and an interactive display method using the same.

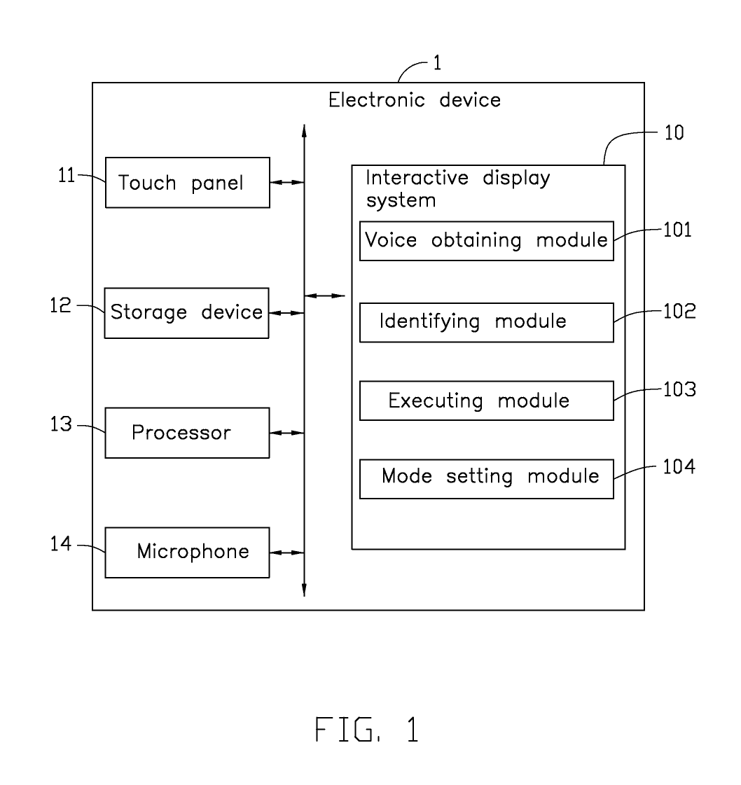

FIG. 1 illustrates an embodiment of an electronic device 1 including an interactive display system 10, according to an exemplary embodiment. The electronic device 1 may be a cell phone, a smart watch, a personal digital assistant, a tablet computer, or any other computing device. The electronic device 1 further includes a touch panel 11. The touch panel 11 is used to input and output relevant data, such as images, for example. In at least one embodiments, the touch panel 11 may be a capacitive touch panel or a resistive touch panel that offers multi-touch capability.

The electronic device 1 further includes a storage device 12 providing one or more memory functions, at least one processor 13, and a microphone 14. In at least one embodiment, the interactive display system 10 may include computerized instructions in the form of one or more programs, which are stored in the storage device 12 and executed by the processor 13 to perform operations of the electronic device 1.

The storage device 12 stores one or more programs, such as programs of the operating system, other applications of the electronic device 1, and various kinds of data, such as animated visual images. In some embodiments, the storage device 12 may include a memory of the electronic device 1 and/or an external storage card, such as a memory stick, a smart media card, a compact flash card, or any other type of memory card. FIG. 1 illustrates only one example of the electronic device 1 that may include more or fewer components than as illustrated, or have a different configuration of the various components. The processor 13 can be a microcontroller. The microphone 14 is electronically coupled to the processor 13 and is configured to pick up voice commands from users.

In at least one embodiment, the interactive display system 10 may include one or more modules, for example, a voice obtaining module 101, an identifying module 102, and an executing module 103. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The voice obtaining module 101 is configured to receive the voice commands picked up from the microphone 14. In addition, the voice obtaining module 101 pre-processes the voice commands, such as samples the voice commands, and filters the sampled voice commands by an anti-aliasing bandpass filtering process, and then denoises the voice commands after the anti-aliasing bandpass filtering process.

The identifying module 102 is configured to acquire characteristics of the voice commands, such as a value of short time average magnitude of the voice commands, a value of short time average energy of the voice commands, a value of linear predictive coding coefficient of the voice commands, and a value of short-time spectrum of the voice commands. Additionally, the identifying module 102 compares the characteristics of the voice commands with a sound database stored in the storage device 12 for identifying the voice commands, and consequently obtains an identification result.

The executing module 103 is configured to execute the data of the animated visual images according to the identification result. Optionally, the data of the sound database can also be executed by the executing module 103. In at least one embodiment, the animated visual images at least include a two-dimensional (2D) cartoon or a 3D cartoon, and both the data of the animated visual images and the data of the sound database correspond to the identification result. That is, a mapping relationship is established between both the data of the animated visual images and the data of the sound database and the identification result. Foe example, when the voice commands, such as “open the document”, is received by the voice obtaining module 101, the executing module 103 executes the data of the animated visual images in response to the voice commands “open the document”. Thus, a 2D/3D cartoon may be shown on the touch panel 11 for indicating a double click action on the document. In another example, when voice commands, such as “what it is your name”, is received by the voice obtaining module 101, the executing module 103 executes the data of the animated visual images and the data of the sound database in response to the voice commands “what it is your name”. Thus, a 2D/3D cartoon may be shown on the touch panel 11 for indicating a self-introduction action, and then a name of the 2D/3D cartoon can be outputted by a speaker (not shown) of the electronic device 1. Therefore, the animated visual images and sound effects are interactive with the users.

The electronic device 1 has a first mode and a second mode. Optionally, the interactive display system 10 further includes a mode setting module 104 configured to control the electronic device 1 to enter the first mode or the second mode. When the mode setting module 104 controls the electronic device 1 to enter the first mode, the executing module 103 only executes the data of the animated visual images. When the mode setting module 104 controls the electronic device 1 to enter the second mode, the executing module 103 executes both the data of the animated visual images and the data of the sound database. Thus, the sound effects may be turned off to meet a special environment, such as in a public occasions. In general, two prompt widows may be shown on the touch panel 11 to facilitate selection of the first mode and the second mode.

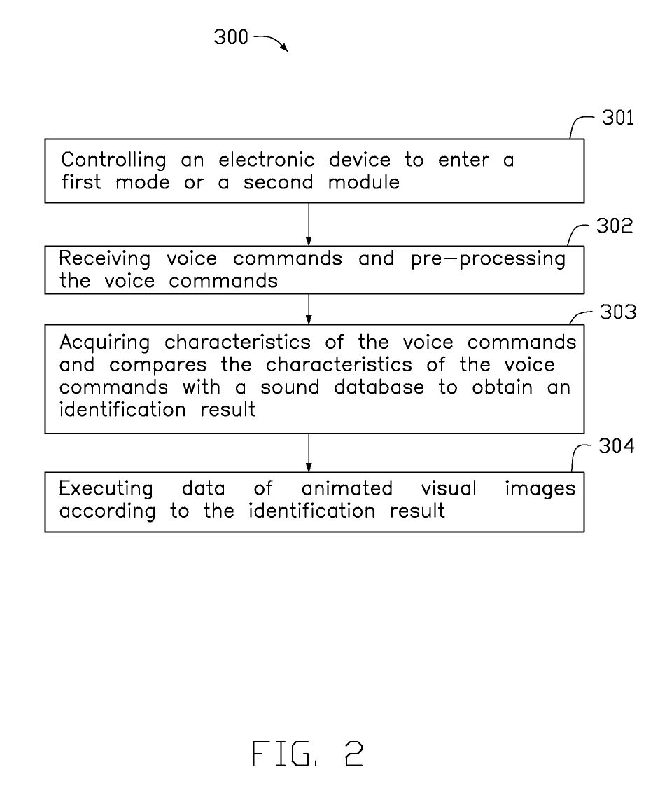

FIG. 2 illustrates a flowchart of an example interactive display method 300 of the disclosure. The interactive display method 300 is provided by way of example, as there are a variety of ways to carry out the interactive display method 300. The interactive display method 300 described below can be carried out using the functional units of the interactive display system 10 as illustrated in FIG. 1, for example, and various elements of this figure are referenced in explaining the example interactive display method 300. Each block shown in FIG. 2 represents one or more processes, methods, or subroutines which are carried out in the example interactive display method 300. Furthermore, the order of blocks is illustrative only and the order of the blocks can change. Additional blocks can be added or fewer blocks may be utilized without departing from the scope of this disclosure. The example interactive display method 300 can begin at block 301.

At block 301, the mode setting module controls the electronic device to enter the first mode or the second module.

At block 302, the voice obtaining module receives the voice commands picked up from the microphone 14 and pre-processes the voice commands.

At block 303, the identifying module acquires the characteristics of the voice commands and compares the characteristics of the voice commands with the sound database for identifying the voice commands, and then the identifying module obtains the identification result.

At block 304, if the electronic device enters the first mode, the executing module only executes the data of the animated visual images, and then a 2D/3D cartoon may be displayed on the electronic device. If the electronic device enters the second mode, the executing module executes both the data of the animated visual images and the data of the sound database, and then a 2D/3D cartoon may be displayed on the electronic device and a sound may be outputted by the electronic device.

In other embodiments, the block 301 can be omitted. At this time, the electronic device enters the second mode by default when the electronic device is turned on.

In summary, the interactive display system 10 includes the voice obtaining module 101 receiving the voice commands, the identifying module 102 comparing the characteristics of the voice commands with the sound database to obtain the identification result, and the executing module 103 executing the data of the animated visual images and the data of the sound database according to the identification result. Thus, the interactive display system 10 is capable of effectively detecting the voice commands of the users, and the animated visual images and the sound effects are interactive with the users, such that an overall controlling performance can be further improved.

The embodiments shown and described above are only examples. Many details are often found in the art such as the other features of the interactive display system and the interactive display method using the same. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device comprising:
a storage device;
at least one processor;
a touch panel for outputting data from the storage device; and
a microphone for obtaining voice commands from a user of the electronic device;
wherein, a voice obtaining module is stored on the storage device and executable by the computer processor and the voice obtaining module receives user voice commands from the microphone and pre-processes the received voice commands;
wherein, an identifying module is stored on the storage device and executable by the computer processor and the identifying module determines characteristics of the received voice commands, compares the determined characteristics of the received voice commands with a sound data base stored in the storage device and obtains an identification result; and
wherein, an executing module is stored on the storage device and executable by the computer processor and the executing module displays animated images from the storage device on the touch panel based on at least in part on the identification results from the identifying module.

2. The electronic device as claimed in claim 1, wherein the electronic device has a first mode and a second mode, a mode setting module is stored on the storage device and executable by the computer processor, the mode setting module controls the electronic device to enter the first mode or the second mode.

3. The electronic device as claimed in claim 2, wherein when the mode setting module controls the electronic device to enter the first mode, the executing module executes the data of the animated visual images, when the mode setting module controls the electronic device to enter the second mode, the executing module executes both the data of the animated visual images and data of the sound database stored in the storage device.

4. The electronic device as claimed in claim 1, wherein the animated visual images at least include a two-dimensional (2D) cartoon or a 3D cartoon.

5. The electronic device as claimed in claim 1, wherein the electronic device is a smart watch.

6. A computer-implemented method for interactive display using an electronic device, the electronic device comprising a microphone, the method comprising execution of steps comprising:
receiving, by a voice obtaining module, voice commands from the microphone and pre-processing the voice commands;
acquiring, by an identifying module, characteristics of the voice commands and comparing the characteristics of the voice commands with a sound database to obtain an identification result; and
executing, by an executing module, data of animated visual images according to the identification result to show the animated visual images.

7. The method as claimed in claim 6, further comprising controlling, by a mode setting module, the electronic device to enter the first mode or the second module.

8. The method as claimed in claim 7, wherein when the electronic device enters the first mode, the executing module executes the data of the animated visual images, when the electronic device enters the second mode, the executing module executes both the data of the animated visual images and data of the sound database.

9. The method as claimed in claim 6, wherein the animated visual images at least include a two-dimensional (2D) cartoon or a 3D cartoon, and the 2D cartoon or the 3D cartoon is shown on a touch screen of the electronic device.

10. A non-transitory storage medium having stored instructions that, when executed by a processor of an electronic device, causes the electronic device to perform a method for interactive display, the electronic device comprising a microphone, the method comprising:
receiving, by a voice obtaining module, voice commands from the microphone and pre-processing the voice commands;
acquiring, by an identifying module, characteristics of the voice commands and comparing the characteristics of the voice commands with a sound database to obtain an identification result; and
executing, by an executing module, data of animated visual images according to the identification result to show the animated visual images.

11. The non-transitory storage medium as claimed in claim 10, wherein the method further comprises controlling, by a mode setting module, the electronic device to enter the first mode or the second module.

12. The non-transitory storage medium as claimed in claim 11, wherein when the electronic device enters the first mode, the executing module executes the data of the animated visual images, when the electronic device enters the second mode, the executing module executes both the data of the animated visual images and data of the sound database.

13. The non-transitory storage medium as claimed in claim 10, wherein the animated visual images at least include a two-dimensional (2D) cartoon or a 3D cartoon, and the 2D cartoon or the 3D cartoon is shown on a touch screen of the electronic device.
